(19) United States
(12) Patent Application Publication
(10) Pub. No.: US 2007/0011228 A1
(43) Pub. Date: Jan. 11, 2007

(54) PORTABLE ELECTRONIC DEVICE WITH FUNCTION OF DISPLAYING A PERSONAL FAVORITE COMPUTER ENVIRONMENT FOR USER

(76) Inventors: Kuan-Hong Hsieh, Shenzhen (CN); Xiao-Guang Li, Shenzhen (CN); Wen-Chuan Lian, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,829

(22) Filed: May 12, 2006

(30) Foreign Application Priority Data
Jun. 24, 2005 (CN) 200510035552.7

(51) Int. Cl. G06F 15/16

(52) U.S. Cl. 709/203

(57) ABSTRACT

A preferred embodiment of a method for implementing a portable electronic device with function of displaying a personal favorite computer environment for user includes the following steps: when the portable electronic device is connected to the computer, the computer executes the application program: changing a configuration pointer of the computer from pointing to the computer configuration data of the computer to pointing to the computer configuration data of the portable electronic device, and, synchronously, changing a disk pointer of the computer from pointing to the main data storage of the computer to pointing to the public data block and the office data block; accessing the office data block to obtain the computer configuration data and “my folders” according to the path pointed by the configuration pointer of the computer; changing paths pointed by the configuration data pointer and the disk pointer of the computer when the connection between the computer and the portable electronic device is disabled.

### FIELD OF THE INVENTION

The present invention generally relates to a portable electronic device with function of displaying a personal favorite computer environment for user.

### DESCRIPTION OF RELATED ART

Computers have become necessary tools in people's daily lives. It is also commonly preferred to store information on computers. In this way information can be more easily shared and distributed.

Users may operate computers in different places such as at home or at one's work location. Users may also choose to use shared computers not belonging to them when their own computers are not accessible. Using the shared computer would mean accessing the system thereof, thus jeopardizing the security of the data stored within. Additionally, while using the shared computer, the computer environment set up may not be that of the favorite computer environment of the user.

By using an external hard disk, a user may use a hard disk tray to couple the external hard disk into another computer's hard disk bay. The system configuration stored in the external hard drive would allow using the resources of the other computer's without accessing the data stored within. However, one shortcoming of the removable external hard disk is that it is too expensive and too heavy resulting in inconvenience when carrying it. Another shortcoming of the external hard drive is that the computer that uses it must have a hard disk bay itself, and this is not common.

A notebook could solve the above problem but it is much more expensive and heavier.

What is needed is a portable electronic device which has less weight and cost less, allowing a user to use a shared computer's resources without accessing the data, and setting up a favorite computer environment accustomed to the user.

### SUMMARY OF INVENTION

A portable electronic device with function of displaying a personal favorite computer environment for user is provided. A preferred embodiment of the portable electronic device includes a transmitting interface, a controller, and a data storage. The data storage further comprises a public data block, and an office data block. The transmitting interface is for performing a data communication between a computer and the portable electronic device; the controller is connected to the transmitting interface and the data storage for controlling the data communication between the portable electronic device and the computer; the public data block for storing data accessible to both the portable electronic device and the computer; and the office data block for storing computer configuration data, at least one predetermined folder, and an application program; wherein the application program comprises: an operation module for changing a configuration pointer of the computer from pointing to the computer configuration data of the computer to pointing to the computer configuration data of the portable electronic device, simultaneously changing a disk pointer of the computer from pointing to a main data storage of the computer to pointing to the public data block and the office data block, and accessing the office data block to obtain the computer configuration data and at least one predetermined folder according to the configuration pointer of the computer; and a pointer reset module for changing the configuration data pointer of the computer from pointing to the computer configuration data of the portable electronic device to pointing to the computer configuration data of the computer, and simultaneously, changing the disk pointer of the computer from the public data block and the office data block to the main data storage, when the connection between the computer and the portable electronic device is disabled.

A method for implementing a portable electronic device with function of displaying a personal favorite computer environment for user is provided. A preferred embodiment of the method comprises connecting the portable electronic device to a computer, wherein, the portable electronic device comprises a transmitting interface, a controller, and a data storage. The data storage further comprises a private data block, a public data block, and an office data block. The office data block stores computer configuration data, at least one predetermined folder and an application program executed on the computer. A configuration pointer of the computer is changed from pointing to the computer configuration data of the computer to pointing to the computer configuration data of the portable electronic device, and, simultaneously, a disk pointer of the computer is changed from pointing to the main data storage of the computer to pointing to the public data block and the office data block. The computer accesses the office data block to obtain the computer configuration data and at least one predetermined folder according to the path pointed by the configuration pointer of the computer. The configuration data pointer of the computer is changed from pointing to the computer configuration data of the portable electronic device to pointing to the computer configuration data of the computer, and simultaneously, the disk pointer of the computer is changes from the public data block and the office data block to the main data storage, when the connection between the computer and the portable electronic device is disabled.

Other advantages and novel features will be drawn from the following detailed description of exemplary embodiments with reference to the attached drawings, in which:

### BRIEF DESCRIPTION OF DRAWINGS

FIG. 1 is a block diagram of a preferred embodiment linking a portable electronic device and a computer in accordance of the present invention;

FIG. 2 is a schematic diagram of main function modules of the application program of FIG. 1; and

FIG. 3 is a flow chart of a preferred method for implementing data communication between the portable electronic device and the computer of FIG. 1, utilizing the application program.

### DETAILED DESCRIPTION

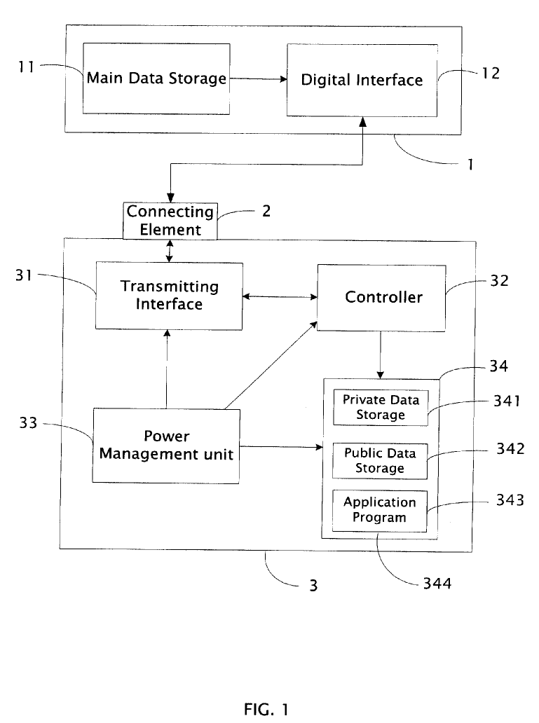

FIG. 1 is a block diagram of a preferred embodiment linking a portable electronic device and a computer in accordance of the present invention. The computer 1 connects to the portable electronic device 3 and configures a favorite computer environment for operating the portable electronic device 3. The computer 1 includes a main data storage 11 and a digital interface 12. The main data storage 11 has a driver therein for driving the portable electronic device 3. The digital interface 12 provides an interface for connecting the portable electronic device 3 thereto. Additionally, the portable electronic device 3 provides a connecting element 2 to connect with computer 1. The connecting element 2 is also of a digital interface. The connecting element 2 could be separated from or incorporated within the portable electronic device 3. For simplicity, in such case, the former (such as that shown in FIG. 1) is adopted.

The portable electronic device 3 (e.g., Audio Player) includes a transmitting interface 31, a controller 32, a power management unit 33, and a data storage 34. The controller 32 is for controlling data communication between the main data storage 11 of the computer 1 and the data storage 34 of the portable electronic device 3. Under the control of the controller 32, the transmitting interface 31 receives data from the main data storage 11 or outputs data from the data storage 34 through the digital interface 12 and the connecting element 2, thereby performing data communication. The power management unit 33 supplies power to the transmitting interface 31, the controller 32, and the data storage 34. The data storage 34 further includes a private data block 341, a public data block 342, and an office data block 343. The private data block 341 is for storing configuration data of the portable electronic device 3. The public data block 342 is for storing data accessible by both the portable electronic device 3 and the computer 1. Adopting the audio player as an example, the data stored in the public data block 342 could be some audio documents. The office data block 343 is for storing the computer configuration data, at least one predetermined folder, namely “my folders”, a playing data, and an application program 344. The computer configuration data includes a favorite computer environment configuration data and a general applications configuration data. The general applications can be such as, for example, Microsoft Word, Microsoft Excel, and so on. The computer environment configuration data is for setting a favorite computer environment to which a user of the portable electronic device is familiar. The general applications configuration data is for setting general applications according to users's; personal preference. “my folders” are for storing important or frequently used data. “my folders” can be such as, for example, my favorite folder, my document folder of a windows operation system, and/or some other user-defined folder. The playing data is for recoding state information of the portable electronic device when it finishes playing. During connecting with the portable electronic device 3, the computer 1 can access the playing data from the office data block 343 of the portable electronic device 3 and recover the playing state of the portable electronic device 3 according to the playing data, in response to a playing operation. Adopting the audio player as an example, the playing data could be the playing song's name, volume, and path in the portable electronic device 3 when the portable electronic device finishes playing.

The application program 344 automatically installs into the computer 1 once the portable electronic device 3 is connected to the computer 1 and automatically uninstalls from the computer 1 when the connection between the computer 1 and the portable electronic device 3 is disabled.

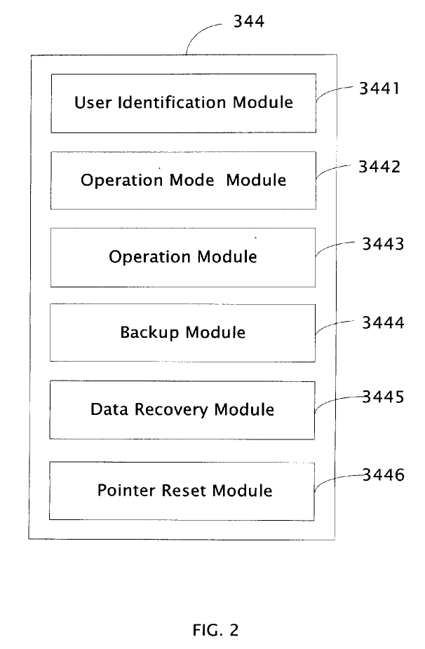

FIG. 2 is a schematic diagram of function modules of the application program 344. The application program 344 includes a user identification module 3441, an operation mode module 3442, an operation module 3443, a backup module 3444, a data recovery module 3445, and a pointer reset module 3446. The user identification module 3441 is for determining whether a user operating the portable electronic device 3 is a legal user through a password authentication system. The user identification module 3441 further provides a dialog box for the user to input a valid user name and a valid password when the portable electronic device 3 is connected to the computer 1. The user identification module 3441 rejects access to the data of the portable electronic device 3 when the username or the password inputted is not correct, thereby enhancing the security of the data thereof. The operation mode module 3442 is for determining an operation mode of the computer 1 according to user's choice. The operation mode includes a host mode and a client mode. The operation module 3443 is for controlling the communication between the computer 1 and the portable electronic device 3. For example, if the operation mode of the computer 1 is in client mode, the computer 1 changes a configuration data pointer of the computer 1 from pointing to the computer configuration data of the computer 1 to pointing to the preferred computer configuration data of the portable electronic device 3. Simultaneously, the computer 1 changes a disk pointer of the computer 1 from pointing to the main data storage 11 of the computer 1 to pointing to the public data block 342 and the office data block 343 of the portable electronic device 3, thereby shielding the main data storage 11 of the computer 1 from being accessed. Accordingly, the computer 1 directly accesses the office data block 343 to obtain the preferred computer configuration data and “my folders” according to paths pointed by the configuration data pointer and disk pointer of the computer 1, thus configuring a favorite computer environment according to the favorite computer environment configuration data. Therefore, the user can operate on the computer 1 in a familiar favorite computer environment. The backup module 3444 is for operating the electronic device 3 in host mode. The user can save documents from the computer 1 to the portable electronic device 3 as “my folders” and can also backup documents from the portable electronic device 3 to the computer 1. The data recovery module 3445 is for accessing the playing data from the office data block 343 of the portable electronic device 3 and recovering the playing state of the portable electronic device 3 according to the playing data, in response to a playing operation during connecting with the portable electronic device 3. The pointer reset module 3446 is for resetting paths pointed by the configuration data pointer and the disk pointer of the computer 1 when the connection between the computer 1 and the portable electronic device 3 is disabled. That is, the pointer reset module 3444 changes the configuration data pointer of the computer 1 from pointing to the preferred computer configuration data of the portable electronic device 3 to pointing to the computer configuration data of the computer 1. Simultaneously, the pointer reset module 3446 changes the disk pointer of the computer 1 from the public data block 342 and the office data block 343 to the main data storage 11.

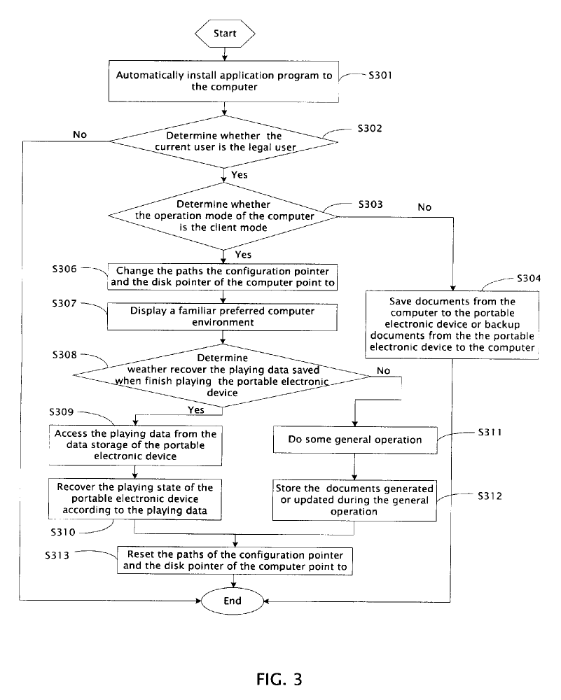

FIG. 3 is a flow chart of a preferred method of implementing the data communication between the computer 1 and the portable electronic device 3 utilizing the application program 343. In step S301, the application program 344 automatically installs itself into the computer 1 when the computer 1 is connected to the portable electronic device 3. In step S302, the user identification module 3441 determines whether the user operating on the portable electronic device 3 is a legal user of the portable electronic device 3 according to the user name and the password inputted. In step 303, the operation mode module 3442 determines whether the operation mode of the computer 1 is in client mode according to the user's selection. In step 304, if the operation mode of the computer 1 is the host mode, the user can save documents from the computer 1 into the portable electronic device 3 as “my folders” and can also backup documents from the portable electronic device 3 to the computer 1. In step 306, if the operation mode of the computer 1 is in client mode, the computer 1 changes a configuration pointer of the computer 1 from pointing to the computer configuration data of the computer 1 to pointing to the preferred computer configuration data of the portable electronic device 3, and, simultaneously, changes a disk pointer of the computer 1 from pointing to the main data storage 11 of the computer 1 to pointing to the public data block 342 and the office data block 343, thereby shielding the main data storage 11 of the computer 1 from being accessed. In step 307, the computer 1 directly accesses the office data block 343 to obtain the computer configuration data and “my folders” according to the path pointed by the configuration pointer and disk pointer of the computer 1, and thus to display a familiar favorite computer environment for the user according to the favorite computer environment configuration data. In step S308, the playing data recovery module 3445 determines weather it is necessary to recover the playing state of the portable electronic device when it finishes playing. In step S309, the computer accesses the playing data from the office data block 343 of the portable electronic device 3 in response to a playing operation. In step S310, the computer 1 recovers the playing state of the portable electronic device 3 according to the playing data. In step S311, the user can execute general operations such as reading, writing, or modifying on the computer 1, if necessary. In step 312, documents generated or updated by general operations are stored to the public data block 342 or office data block 343 of the portable electronic device 3. In step 313, when the connection between the computer 1 and the portable electronic device 3 is disabled, the pointer reset module changes the configuration pointer and the disk pointer of the computer 1 to point to the path of computer configuration data and the main data storage of the computer respectively.

What is claimed is:

1. A portable electronic device with function of displaying a personal favorite computer environment for user, comprising:
a transmitting interface for performing a data communication between a computer and the portable electronic device;
a data storage comprising:
a public data block for storing data that both the portable electronic device and the computer can access; and
an office data block for storing computer configuration data, at least one predetermined folder, and an application program;
a controller, connected to the transmitting interface and the data storage, for controlling the data communication between the portable electronic device and the computer;
wherein the application program comprises:
an operation module for changing a configuration pointer of the computer from pointing to the computer configuration data of the computer to pointing to the preferred computer configuration data of the portable electronic device, simultaneously changing a disk pointer of the computer from pointing to a main data storage of the computer to pointing to the public data block and the office data block of the portable electronic device respectively, and accessing the office data block of the portable electronic device to obtain the computer configuration data and the at least one predetermined folder according to the configuration pointer of the computer; and
a pointer reset module for changing the configuration data pointer from pointing to the computer configuration data of the portable electronic device to pointing to the computer configuration data of the computer, and simultaneously, resetting the disk pointer from the public data block and the office data block to the main data storage, when the connection between the computer and the portable electronic device is disabled.

2. The portable electronic device as described in claim 1, wherein, the data storage further comprises a private data block for storing configuration data of the portable electronic device.

3. The portable electronic device as described in claim 1, wherein, the preferred computer configuration data includes a favorite computer environment configuration data for setting a favorite environment for the computer.

4. The portable electronic device as described in claim 1, wherein, the computer configuration data includes a general applications configuration data for setting general applications according to users's; personal preference.

5. The portable electronic device as described in claim 1, wherein, the office data block further stores a playing data for recovering a playing state of the portable electronic device when it is finishes playing.

6. The portable electronic device as described in claim 1, wherein the at least one predetermined folder contains backups of important or frequently used data from the computer.

7. The portable electronic device as described in claim 1, wherein, the application program further comprises a user identification module for determining whether a user operating on the portable electronic device is a legal user through a password authentication system.

8. The portable electronic device as described in claim 1, wherein, the application program further comprises a backup module for saving documents from the computer to the portable electronic device as the at least one predetermined folder and backing-up documents from the portable electronic device to the computer.

9. The portable electronic device as described in claim 1, wherein, the operation mode of the computer includes a client mode and a host mode.

10. The portable electronic device as described in claim 9, wherein, the application program further comprises an operation mode for determining an operation mode of the computer according to the inputted selection.

11. A method for implementing a portable electronic device with function of displaying a personal favorite computer environment for user, comprising:
connecting the portable electronic device to a computer, wherein, the portable electronic device comprises a transmitting interface, a controller, and a data storage and the data storage further comprising a private data block, a public data block, and an office data block and the office data block stores computer configuration data, at least one predetermined folder and an application program executed on the computer;
changing a configuration pointer of the computer from pointing to the computer configuration data of the computer to pointing to the preferred computer configuration data of the portable electronic device, and, simultaneously, changing a disk pointer of the computer from pointing to a main data storage of the computer to pointing to the public data block and the office data block of the portable electronic device;
accessing the office data block to obtain the preferred computer configuration data and the at least one predetermined folder according to the path pointed by the configuration pointer of the computer;
changing the configuration data pointer of the computer from pointing to the computer configuration data of the portable electronic device to pointing to the preferred computer configuration data of the computer, and simultaneously, resetting the disk pointer of the computer from the public data block and the office data block to the main data storage, when the connection between the computer and the portable electronic device is disabled.

12. The portable electronic device as described in claim 11, wherein, the data storage further comprises a private data block for storing configuration data of the portable electronic device.

13. The portable electronic device as described in claim 11, wherein, the preferred computer configuration data includes a favorite computer environment configuration data for setting a favorite computer environment for the user.

14. The portable electronic device as described in claim 11, wherein, the computer configuration data includes a general applications configuration data is for setting general applications according to personal preference.

15. The portable electronic device as described in claim 11, wherein, the at least one predetermined folder contains backups of important or used frequently data from the computer.

16. The portable electronic device as described in claim 11, wherein, further comprising the step of determining whether the user is the legal user after connecting the portable electronic device to a computer.

17. The portable electronic device as described in claim 11, wherein, the operation mode of the computer includes a client mode and a host mode.

18. The portable electronic device as described in claim 17, wherein, further comprising the step of determining the operation mode of the computer before changing a configuration pointer of the computer.

19. The portable electronic device as described in claim 11, wherein, the office data block further stores a playing data for recovering a playing state of the portable electronic device when it finishes playing.

20. The portable electronic device as described in claim 19, wherein, further comprising the step of recovering the playing state of the portable electronic device according to the playing data.
